(19) United States
(12) Patent Application Publication
(10) Pub. No.: US 2022/0092475 A1
(43) Pub. Date: Mar. 24, 2022

(54) LEARNING DEVICE, LEARNING METHOD, AND LEARNING PROGRAM

(71) Applicant: NEC Corporation, Minato-ku, Tokyo (JP)

(72) Inventors: Yasuhiro SOGAWA, Tokyo (JP); Tomoya SAKAI, Tokyo (JP)

(73) Assignee: NEC Corporation, Minato-ku, Tokyo (JP)

(21) Appl. No.: 17/419,974

(22) PCT Filed: Jan. 11, 2019
(86) PCT No.: PCT/JP2019/000704

§ 371 Date: Jun. 30, 2021

(51) Int. Cl. G06N 20/00; G06K 9/62

(52) U.S. Cl. CPC G06N 20/00; G06K 9/6259; G06K 9/6215

(57) ABSTRACT

A target task attribute estimation unit 81 estimates an attribute vector of an existing predictor based on samples in a domain of a target task, and estimates an attribute vector of the target task based on a transformation method for transforming labeled samples into a space consisting of the estimated attribute vector based on a result of applying the labeled samples of the target task to the predictor. A prediction value calculation unit 82 calculates a prediction value of a prediction target sample to be transformed by the transformation method based on the attribute vector of the target task.

### TECHNICAL FIELD

The present invention relates to a learning device, a learning method, and a learning program for learning a new model using existing models.

### BACKGROUND ART

In order to create new value in the business scene, new products and services continue to be devised and offered every day through creative activities. In order to generate profits efficiently, a prediction based on data is often made. However, since forecasts (sometimes called new tasks) for new products and services have been provided for a short period of time, it is difficult to apply predictive analysis techniques that assume large-scale data.

Specifically, since it is generally difficult to build prediction models and classification models based on statistical machine learning from only a small amount of data, it is difficult to say that prediction models and classification methods can be robustly simulated. Therefore, various learning methods based on a small amount of data have been proposed. For example, the non patent literature 1 describes one-shot learning. In the one-shot learning described in the non patent literature 1, a neural network is trained using a structure that ranks the similarity between inputs.

The one-shot learning is also described in non patent literature 2. In the one-shot learning described in the non patent literature 2, a small labeled support set and unlabeled examples are mapped to labels to learn a network that excludes the need for fine-tuning to adapt to new class types.

### CITATION LIST

### Non Patent Literatures

Non Patent Literature 1: Koch, G., Zemel, R., & Salakhutdinov, R., “Siamese neural networks for one-shot image recognition”, ICML Deep Learning Workshop, Vol. 2, 2015.

Non Patent Literature 2: Vinyals, O., Blundell, C., Lillicrap, T., & Wierstra, D., “Matching networks for one shot learning”, Advances in Neural Information Processing Systems 29, pp. 3630-3638, 2016.

### SUMMARY OF INVENTION

### Technical Problem

On the other hand, the one-shot learning (sometimes called “Few-shot learning”) described in the non patent literatures 1 and 2), it is necessary to integrate or refer to data of existing related tasks in order to build a prediction model for a new task with only a small amount of data with high accuracy.

Depending on the number of tasks, the scale of the data is huge, and if the data is distributively managed, it takes a lot of time and effort to aggregate the data. Even if the data is aggregated, it is necessary to process the huge amount of aggregated data, and it is inefficient to build a prediction model for a new task in a short time.

In addition, in recent years, due to privacy issues, there are circumstances where data is not provided, but only a model used for prediction and other purposes is provided. In this case, it is not possible to access the data used to build the model itself. Therefore, in order to build a prediction model in a short period of time, it is possible to use existing prediction models that have already been trained. However, it is difficult to manually select necessary models from a wide variety of models and combine them appropriately to build an accurate prediction model. Therefore, it is desirable to be able to learn a highly accurate model from a small number of data while making use of existing resources (i.e., existing models).

Therefore, it is an object of the present invention to provide a learning device, a learning method, and a learning program that can learn a highly accurate model from a small number of data using existing models.

### Solution to Problem

A learning device according to the present invention includes a target task attribute estimation unit which estimates an attribute vector of an existing predictor based on samples in a domain of a target task, and estimates an attribute vector of the target task based on a transformation method for transforming labeled samples into a space consisting of the attribute vector estimated based on a result of applying the labeled samples of the target task to the predictor, and a prediction value calculation unit which calculates a prediction value of a prediction target sample to be transformed by the transformation method based on the attribute vector of the target task.

A learning method according to the present invention, executed by a computer, includes estimating an attribute vector of an existing predictor based on samples in a domain of a target task, and estimating an attribute vector of the target task based on a transformation method for transforming labeled samples into a space consisting of the attribute vector estimated based on a result of applying the labeled samples of the target task to the predictor, and calculating a prediction value of a prediction target sample to be transformed by the transformation method based on the attribute vector of the target task.

A learning program according to the invention causes a computer to execute a target task attribute estimation process of estimating an attribute vector of an existing predictor based on samples in a domain of a target task, and estimating an attribute vector of the target task based on a transformation method for transforming labeled samples into a space consisting of the attribute vector estimated based on a result of applying the labeled samples of the target task to the predictor, and a prediction value calculation process of calculating a prediction value of a prediction target sample to be transformed by the transformation method based on the attribute vector of the target task.

### Advantageous Effects of Invention

According to the present invention, a highly accurate model can be learned from a small number of data using existing models.

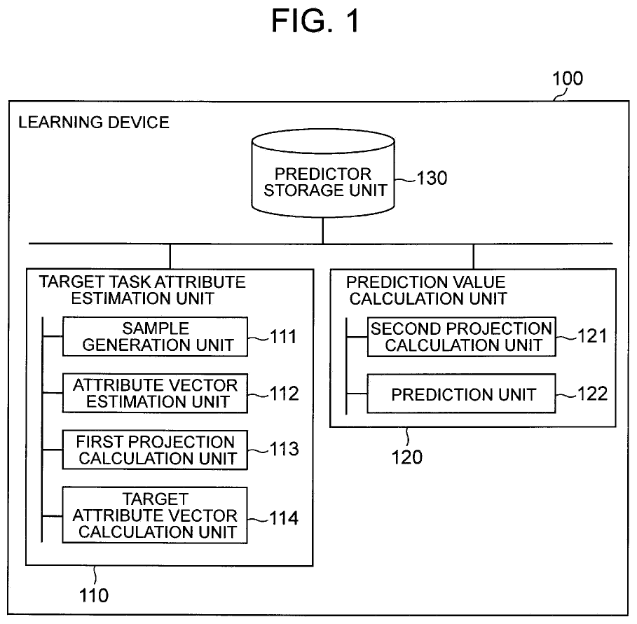

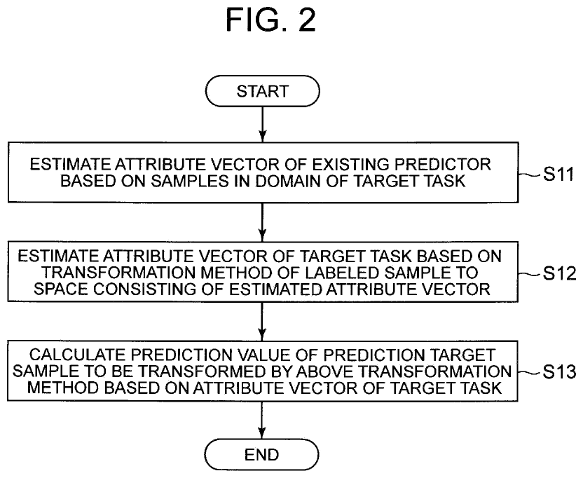

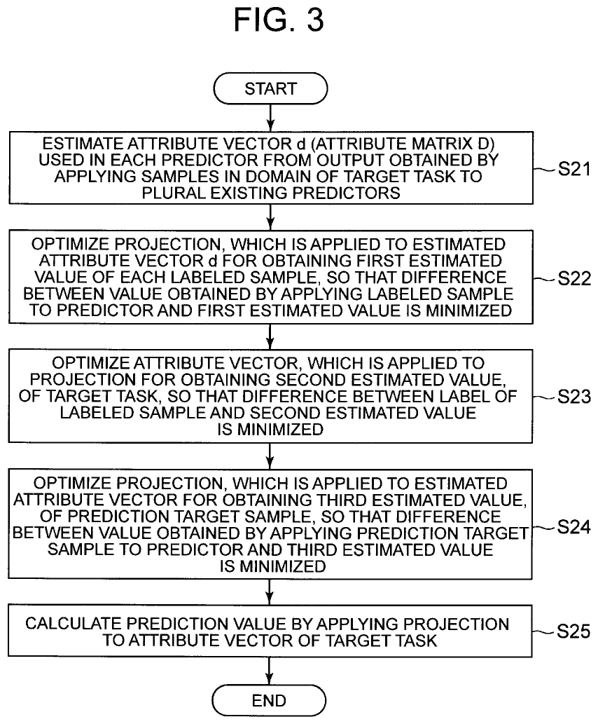

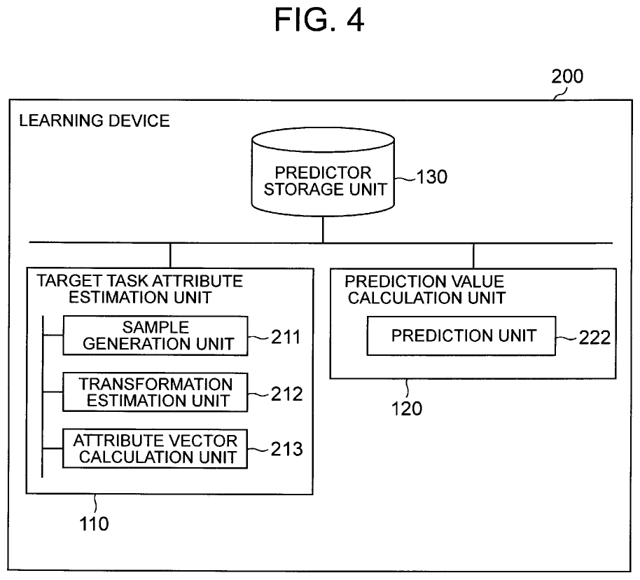

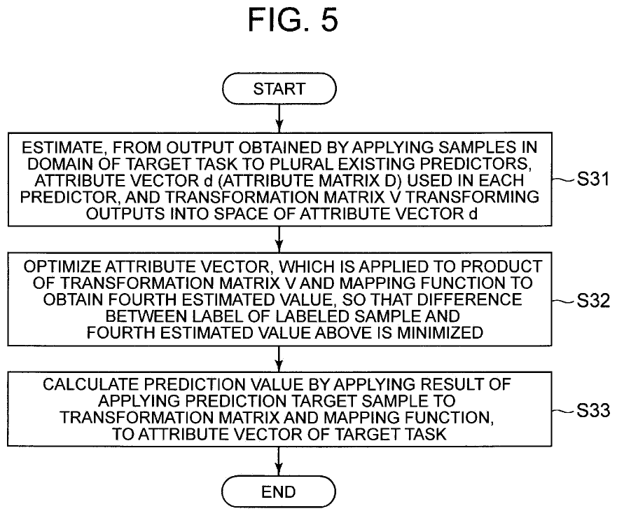

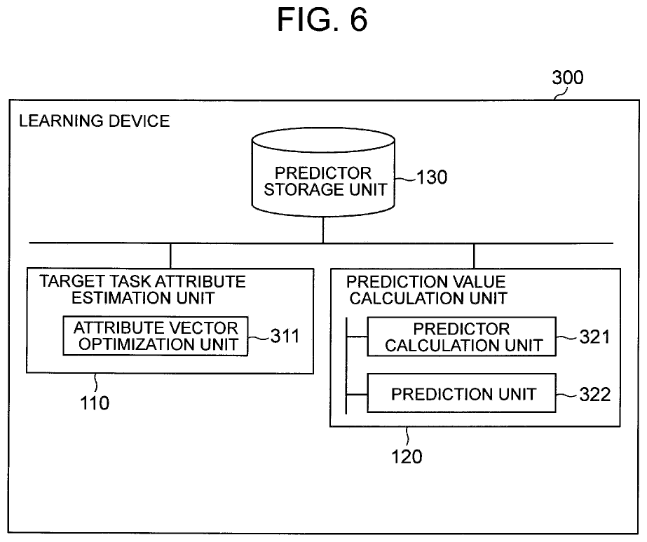

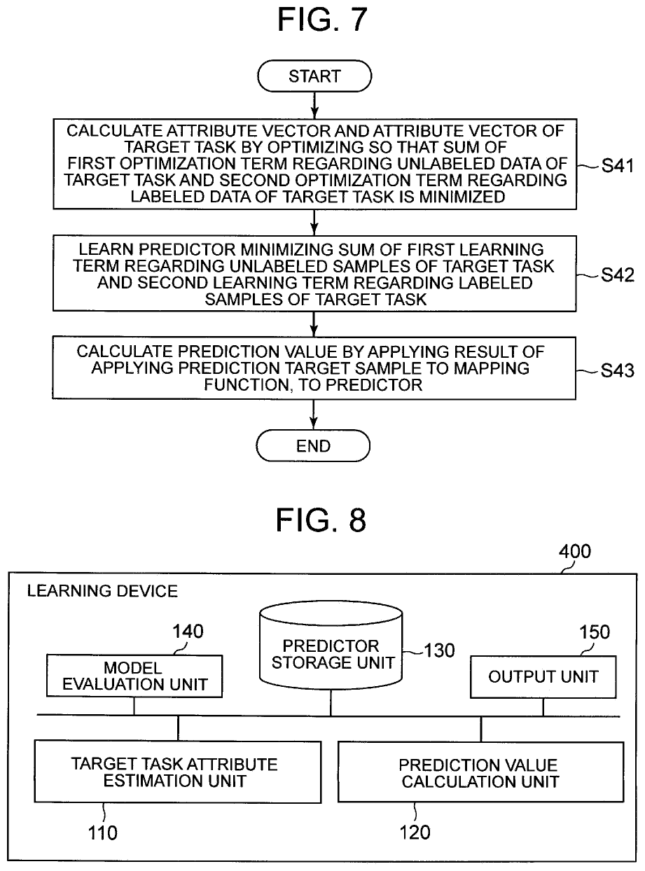

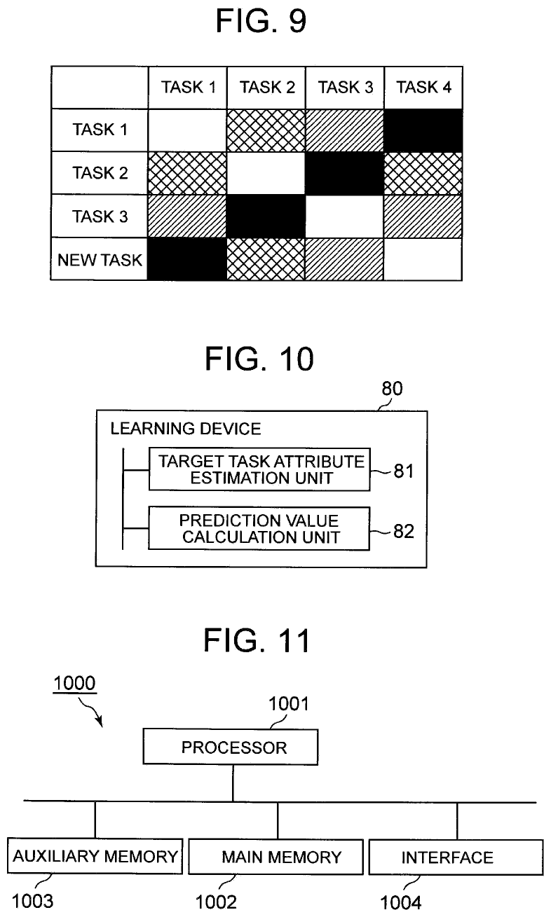

### BRIEF DESCRIPTION OF DRAWINGS

[FIG. 1] It depicts a block diagram showing a first example embodiment of a learning device according to the present invention.

[FIG. 2] It depicts a flowchart showing an operation example of a learning device of the first example embodiment.

[FIG. 3] It depicts a flowchart showing a specific operation example of a learning device of the first embodiment.

[FIG. 4] It depicts a block diagram showing a second example embodiment of a learning device according to the present invention.

[FIG. 5] It depicts a flowchart showing an operation example of a learning device of the second example embodiment.

[FIG. 6] It depicts a block diagram showing a third example embodiment of a learning device according to the present invention.

[FIG. 7] It depicts a flowchart showing an operation example of a learning device of the third example embodiment.

[FIG. 8] It depicts a flowchart showing an operation example of a learning device of the fourth example embodiment.

[FIG. 9] It depicts an explanatory diagram showing an example of the process of visualizing similarity.

[FIG. 10] It depicts a block diagram showing a summarized learning device according to the present invention.

[FIG. 11] It depicts a summarized block diagram showing a configuration of a computer for at least one example embodiment.

### DESCRIPTION OF EMBODIMENTS

In the following description, a new prediction target, such as a new product or service, is described as a target task. In the following implementation, it is assumed that the target task has a small number of samples (a “few” samples). Here, a small number is assumed to be, for example, a dozen to several hundred samples, depending on the complexity of the task. The deliverables generated for prediction are referred to as predictors, prediction models, or simply models. A set of one or more attributes is called an attribute vector. The predictor uses each attribute in the attribute vector as an explanatory variable. The predictor uses each attribute in the attribute vector as an explanatory variable. In other words, the attribute vector refers to the attributes of respective tasks.

Hereinafter, T trained predictors are denoted by {hₜ(x)|t=1, . . . , T}. The sample (data) of the target task is represented by D_{T+1}:={(xₙ, yₙ)|n=1, . . . , N_{T+1}}. In other words, the value of N_{T+1} is assumed to be small on the assumption that a number of samples of the target task is small.

A task for which a predictor has already been generated (learned) is referred to as a related task. In this example embodiment, the predictor constructed for a related task similar to the target task is used to generate the attribute vector used in the predictor for the target task from an input-output relationship of the predictor. Here, similar related tasks mean a group of tasks that can be composed of the same explanatory variables (features) as those of the target task due to the nature of the algorithm. Specifically, a similar means a target that belongs to a predefined group, such as a product that belongs to a specific category. Samples of the target task or a range similar to the target task (i.e., related tasks) are described as samples in the domain of the target task.

The samples include those with labels (correct labels) and those without labels (correct labels). Hereafter, the sample with a label is referred to as “labeled sample”. The sample without a label is referred to as “unlabeled sample”. In the following explanation, the expression “sample” means either or both a labeled sample and an unlabeled sample.

Hereinafter, example embodiments of the present invention will be described with reference to the drawings.

### Example Embodiment 1

FIG. 1 is a block diagram showing a first example embodiment of a learning device according to the present invention. The learning device 100 of this example embodiment comprises a target task attribute estimation unit 110, a prediction value calculation unit 120, and a predictor storage unit 130.

The predictor storage unit 130 stores learned predictors. The predictor storage unit 130 is realized by a magnetic disk device, for example.

The target task attribute estimation unit 110 estimates an attribute vector of an existing (learned) predictor based on the sample in the domain of the target task. The target task attribute estimation unit 110 also estimates an attribute vector of the target task based on the transformation method of that labeled sample to a space consisting of the attribute vector estimated based on the result of applying the labeled sample of the target task to the existing predictor.

The prediction value calculation unit 120 calculates a prediction value of the prediction target sample to be transformed by the above transformation method based on the estimated attribute vector of the target task.

Hereinafter, the detailed structures of the target task attribute estimation unit 110 and the prediction value calculation unit 120 will be described.

The target task attribute estimation unit 110 of this example embodiment includes a sample generation unit 111, an attribute vector estimation unit 112, a first projection calculation unit 113, and a target attribute vector calculation unit 114.

The sample generation unit 111 randomly generates samples in the domain of the target task. Any method of generating the samples is utilized, and the sample may be generated by randomly assigning arbitrary value to each attribute.

The samples of the target task itself, which have been prepared in advance, may be used as samples without generating new samples. The samples of the target task may be labeled samples or unlabeled samples. In this case, the target task attribute estimation unit 110 may not include the sample generation unit 111. Otherwise, the sample generation unit 111 may generate a sample that is a convex combination of samples of the target task. In the following description, a set of generated samples may be denoted by S.

The attribute vector estimation unit 112 estimates an attribute matrix D, consisting of the attribute vectors d used in each of the predictors, from the outputs (samples+values) obtained by applying the samples in the domain of the target task to plural existing predictors hₜ(x).

Specifically, the attribute vector estimation unit 112 optimizes the attribute matrix D consisting of the attribute vectors d so as to minimize the difference between the value calculated by the inner product of the sample x with the projection α and the value output by applying the sample x to the predictor hₜ(x). Here, the projection α is a value corresponding to each sample xᵢ that can reproduce each output by multiplication of the sample xᵢ and the attribute vector d. The estimated attribute matrix D\hat{ }(circumflex on D) is estimated by following Equation 1.

$$[ Math . 1 ]$$

$$\hat{D} , \hat{α} = {arg min}_{D ∈ 𝒞 , α ∈ {ℝ}^{\vert 𝒮 \vert \times p}} \frac{1}{\vert 𝒮 \vert} {\sum }_{i = 1}^{\vert 𝒮 \vert} ( \frac{1}{2} {‖ h ( {x}_{i} ) - D {α}_{i} ‖}_{2}^{2} + λ {‖ {α}_{i} ‖}_{1} ) \\ 𝒞 \text{:=} \{ D ∈ {ℝ}^{T \times p} s . t . ∀ t = 1 , … , T , {d}_{t}^{T} {d}_{t} \leq 1 \} \qquad ( Equation 1 )$$

In Equation 1, C is a set of constraints to prevent each attribute vector d from becoming large, and p is the maximum number of types of elements of the attribute vector. In addition, although L1 regularization with respect to α is illustrated in Equation 1, it may include any regularization such as L1L2 regularization. The attribute vector estimation unit 112 may optimize Equation 1 using existing dictionary learning schemas, such as K-SVD (k-singular value decomposition) and MOD (Method of Optimal Directions). Since Equation 1 shown above can be optimized using the same method as dictionary learning, the attribute matrix D may be referred to as a dictionary.

Since the estimated attribute vector dₜ corresponds to the “attribute” of so-called zero-shot learning, the attribute vector dₜ can be treated in the same way in zero-shot learning.

The first projection calculation unit 113 calculates the projection α, which is applied to the estimated attribute vector d (more specifically, the attribute matrix D) to obtain an estimated value (hereinafter, referred to as the first estimated value), of each labeled sample (xᵢ, yᵢ) (i=1, . . . , N_{T+1}), so that the difference between a value obtained by applying the labeled sample (xᵢ, yᵢ) to the predictor h and the first estimated value above is minimized.

Specifically, the first projection calculation unit 113 may calculate the projection vector α\hat{ }ᵢ (circumflex on αᵢ) corresponding to xᵢ by calculating Equation 2 illustrated below for the labeled samples (xᵢ, yᵢ) of the target task, respectively. The first projection calculation unit 113 may solve Equation 2 illustrated below as, for example, Lasso's problem.

$$[ Math . 2 ]$$

$${\hat{α}}_{i} = {arg min}_{{α}_{i}} ( \frac{1}{2} {‖ h ( {x}_{i} ) - \hat{D} {α}_{i} ‖}_{2}^{2} + λ {‖ {α}_{i} ‖}_{1} ) \qquad ( Equation 2 )$$

The target attribute vector calculation unit 114 calculates the attribute vector d_{T+1}, which is applied to the calculated projection α to obtain an estimated value (hereinafter, referred to as the second estimated value), of the target task, so that the difference between the label y of the labeled sample of the target task and the second estimated value above is minimized.

Specifically, the target attribute vector calculation unit 114 may calculate the attribute vector d\hat{ }_{T+1} (circumflex on d_{T+1}) of the target task using the yᵢ of the labeled samples (xᵢ, yᵢ) of the target task and the calculated projection α, and using Equation 3 illustrated below. The target attribute vector calculation unit 114 can obtain a solution to Equation 3 illustrated below by using a method similar to the method for calculating the above Equation 1.

$$[ Math . 3 ]$$

$${\hat{d}}_{T + 1} = {arg min}_{{d}_{T + 1} ∈ \{ {ℝ}^{p} , s . t . {d}_{T + 1}^{T} {d}_{T + 1} \leq 1 \}} {\sum }_{i = 1}^{{N}_{T + 1}} ( \frac{1}{2} {( {y}_{i} - {d}_{T + 1}^{T} {\hat{α}}_{i} )}^{2} ) \qquad ( Equation 3 )$$

The prediction value calculation unit 120 of this example embodiment includes a second projection calculation unit 121 and a prediction unit 122.

The second projection calculation unit 121 calculates the projection α\hat{ }_{new}, which is applied to an estimated attribute vector d to obtain an estimated value (hereinafter, referred to as the third estimated value), of the prediction target sample x_{new}, so that the difference between the value obtained by applying the prediction target sample x_{new} to the predictor h and the third estimated value above is minimized. Specifically, the second projection calculation unit 121 may calculate the projection vector α\hat{ }_{new} for the prediction target sample x_{new} of the target task in the same way as the method for calculating the above Equation 2.

The prediction unit 122 calculates the prediction value yₙ by applying (specifically, calculating the inner product) the projection α_{new} to the attribute vector d_{T+1} of the target task.

The target task attribute estimation unit 110 (more specifically, the sample generation unit 111, the attribute vector estimation unit 112, the first projection calculation unit 113, and the target attribute vector calculation unit 114) and the prediction value calculation unit 120 (more specifically, the second projection calculation unit 121 and the prediction unit 122) are realized by a processor (for example, CPU (Central Processing Unit), GPU (Graphics Processing Unit), FPGA (field programmable gate array)) of a computer that operates according to a program (learning program).

For example, the program may be stored in a storage unit (not shown) of the learning device, and the processor may read the program and operate as the target task attribute estimation unit 110 (more specifically, the sample generation unit 111, the attribute vector estimation unit 112, the first projection calculation unit 113, and the target attribute vector calculation unit 114) and the prediction unit 120 (more specifically, the second projection calculation unit 121 and the prediction unit 122) according to the program. In addition, the function of the learning device may be provided in a SaaS (Software as a Service) manner.

The target task attribute estimation unit 110 (more specifically, the sample generation unit 111, the attribute vector estimation unit 112, the first projection calculation unit 113, and the target attribute vector calculation unit 114) and the prediction value calculation unit 120 (more specifically, the second projection calculation unit 121 and the prediction unit 122) may be realized by dedicated hardware, respectively. In addition, some or all of each component of each device may be realized by a general-purpose or dedicated circuit (circuitry), a processor, etc. or a combination of these. They may be configured by a single chip or by multiple chips connected through a bus. Some or all of components of each device may be realized by a combination of the above-mentioned circuitry, etc. and a program.

In the case where some or all of the components of the learning device are realized by a plurality of information processing devices, circuits, or the like, the plurality of information processing devices, circuits, or the like may be centrally located or distributed. For example, the information processing devices, circuits, etc. may be realized as a client-server system, a cloud computing system, etc., each of which is connected through a communication network.

Next, the example of operation of the learning device of this example embodiment will be described. FIG. 2 is a flowchart showing an example of operation of the learning device 100 of this example embodiment.

The target task attribute estimation unit 110 estimates an attribute vector of the existing predictor based on samples in the domain of the target task (step S1). The target task attribute estimation unit 110 estimates an attribute vector of the target task based on the transformation method of the labeled sample to a space consisting of the estimated attribute vector (step S2). The prediction value calculating unit 120 calculates a prediction value of the prediction target sample to be transformed by the above transformation method, based on the attribute vector of the target task (step S3).

FIG. 3 is a flowchart showing a specific example of the operation of the learning device 100.

The attribute vector estimating unit 112 estimates the attribute vector d (attribute matrix D) used in each of the predictors from outputs obtained by applying the samples in the domain of the target task to plural existing predictors (step S21). The first projection calculation unit 113 optimizes the projection, which is applied to the estimated attribute vector d to obtain the first estimated value of each labeled sample, so that the difference between a value obtained by applying the labeled sample to the predictor h and the first estimated value is minimized (step S22). The target attribute vector calculation unit 114 optimizes the attribute vector, which is applied to the projection to obtain the second estimated value, of the target task, so that the difference between the label of the labeled sample and the second estimated value is minimized (step S23).

The second projection calculation unit 121 optimizes the projection α_{new}, which is applied to the estimated attribute vector to obtain the third estimated value, of the prediction target sample, so that the difference between the value obtained by applying the prediction target sample to the predictor and the third estimated value is minimized (step S24). The prediction unit 122 calculates a prediction value by applying the projection α_{new} to the attribute vector d_{T+1} of the target task (step S25).

As described above, in this example embodiment, the attribute vector estimation unit 112 estimates the attribute vector d to be used in each predictor from the outputs obtained by applying samples to plural existing predictors, and the first projection calculation unit 113 optimizes the projection of each labeled sample so that the difference between the value obtained by applying the labeled sample to the predictor and the first estimated value is minimized of each labeled sample so that the difference between the value obtained by applying the labeled sample to the predictor and the first estimated value is minimized. Then, the target attribute vector calculation unit 114 optimizes the attribute vector of the target task so that the difference between the label of the labeled sample and the second estimated value is minimized.

Furthermore, the second projection calculation unit 121 calculates the projection α_{new} of the prediction target sample x_{new} so that the difference between a value obtained by applying the target sample to the predictor and the third estimated value is minimized, and the prediction unit 122 calculates the prediction value by applying the projection α_{new} to the attribute vector d_{T+1} of the target task.

Therefore, a highly accurate model can be learned efficiently (in a short time) from a small number of data, using existing models. Specifically, in this example embodiment, it becomes to be possible to perform more accurate prediction by calculating the projection vector each time a new sample to be predicted is obtained.

### Example Embodiment 2

Next, the second example embodiment of the learning device according to the present invention will be described. FIG. 4 is a block diagram showing the second example embodiment of the learning device according to the present invention. Similar to the first example embodiment, the learning device 200 of this example embodiment has a target task attribute estimation unit 110, a prediction value calculation unit 120, and a predictor storage unit 130. However, the target task attribute estimation unit 110 and the prediction value calculation unit 120 of the second example embodiment differ from the first example embodiment in their configuration contents.

The target task attribute estimation unit 110 of this example embodiment includes a sample generation unit 211, a transformation estimation unit 212, and an attribute vector calculation unit 213.

The sample generation unit 211 generates samples in the domain of the target task in the same way as the sample generation unit 111 of the first example embodiment.

The transformation estimation unit 212 estimates the attribute matrix D consisting of the attribute vectors d used in each of the above predictors, and a transformation matrix V which transforms outputs into a space of the attribute vector d, from the above outputs (samples+values) of the predictors obtained by applying the samples in the domain of the target task to plural existing predictors hₜ(x).

Specifically, the transformation estimation unit 212 optimizes the attribute matrix D consisting of the attribute vectors d, and the transformation matrix V, so that the difference between a value calculated by a product of a vector obtained by applying the sample x to a feature mapping function φ(R^{d}→R^{b}), the transformation matrix V and the attribute matrix D, and a value output by applying the sample x to the predictor hₜ(x) is minimized. Here, the feature mapping function φ corresponds to so-called transformation of feature values (attribute design) performed in prediction, etc., which represents the transformation between attributes. The feature mapping function φ is represented by an arbitrary function that is defined in advance. The attribute matrix D\hat{ }(circumflex on D) and the transformation matrix V\hat{ }(circumflex on V) are estimated by Equation 4, which is illustrated below.

$$[ Math . 4 ]$$

$$\hat{D} , \hat{V} \text{:=} {argmin}_{𝒟 ∈ 𝒞 , V ∈ {ℝ}^{p \times b}} \frac{1}{\vert 𝒮 \vert} {\sum }_{i = 1}^{\vert 𝒮 \vert} {‖ h ( {x}_{i} ) - DV ϕ ( {x}_{i} ) ‖}_{2}^{2} + λ {‖ V ‖}_{Fro}^{2} \\ 𝒞 \text{:=} \{ D ∈ {ℝ}^{T \times p} s . t . ∀ t = 1 , ⋯ , T , {d}_{t}^{T} {d}_{t} \leq 1 \} \qquad ( Equation 4 )$$

In Equation 4, C is, as in Equation 1, a set of constraints to prevent each attribute vector d from being large, and p is the maximum number of types of elements in the attribute vector. As in Equation 1, Equation 4 may also include any regularization.

The attribute vector calculation unit 213 calculates the attribute vector d_{T+1}, which is applied to a product of the transformation matrix V and the mapping function φ to obtain an estimated value (hereinafter, referred to as the fourth estimated value), of the target task, so that the difference between the label yᵢ of the labeled sample (xᵢ, yᵢ) and the fourth estimated value above is minimized.

Specifically, the attribute vector calculation unit 213 may calculate the attribute vector d\hat{ }_{T+1} (circumflex on d_{T+1}) of the target task using the yᵢ of the labeled sample (xᵢ, yᵢ) of the target task and the estimated transformation matrix V, using Equation 5 illustrated below.

$$[ Math . 5 ]$$

$${\hat{d}}_{T + 1} := {argmin}_{{d}_{T + 1} ∈ \{ d ∈ {ℝ}^{p} \vert {d}_{T + 1}^{T} {d}_{T + 1} \leq 1 \}} {\sum }_{i = 1}^{{N}_{T + 1}} \frac{1}{2} {( {y}_{i} - {d}_{T + 1}^{T} \hat{V} ϕ ( {x}_{i} ) )}^{2} \qquad ( Equation 5 )$$

The prediction value calculation unit 120 of this example embodiment includes a prediction unit 222.

The prediction unit 222 calculates a prediction value by applying the transformation matrix V and a result of applying the prediction target sample x_{new} to the mapping function φ, to the attribute vector d_{T+1} of the target task. The prediction unit 222 may, for example, calculate the prediction value by the method illustrated in Equation 6 below.

[Math. 6]

ŷ_{new}=\hat{d}_{T+1}\hat{V}ϕ(x_{new}) (Equation 6)

The target task attribute estimation unit 110 (more specifically, the sample generation unit 211, the transformation estimation unit 212, and the attribute vector calculation unit 213) and the prediction value calculation unit 120 (more specifically, the prediction unit 222) are realized by a processor of a computer that operates according to a program (learning program).

Next, the example of operation of the learning device of this example embodiment will be described. FIG. 5 is a flowchart showing an example of operation of the learning device 200 of this example embodiment.

The transformation estimation unit 212 estimates the attribute vector d (attribute matrix D) used in each of the predictors, and a transformation matrix V transforming outputs into a space of the attribute vector d, from the above outputs (samples+values) obtained by applying the samples in the domain of the target task to plural existing predictors hₜ(x) (step S31). The attribute vector calculating unit 213 optimizes the attribute vector d_{T+1}, which is applied to a product of the transformation matrix V and the mapping function φ to obtain the fourth estimated value, of the target task, so that the difference between the label y of the labeled sample and the fourth estimated value above is minimized (step S32). The prediction unit 222 calculates a prediction value by applying the transformation matrix V and a result of applying the prediction target sample x_{new} to the transformation matrix V and the mapping function φ, to the attribute vector d_{T+1} of the target task (step S33).

As described above, in this example embodiment, the transformation estimation unit 212 estimates the attribute vector d used in each predictor and transformation matrix V from the outputs obtained by applying samples to plural existing predictors, and the attribute vector calculation unit 213 optimizes the attribute vector d_{T+1} of the target task, so that the difference between the label y of the labeled sample and the fourth estimated value above is minimized. Then, the prediction unit 222 calculates a prediction value by applying the transformation matrix V and a result of applying the prediction target sample x_{new} to the mapping function φ, to the attribute vector d_{T+1} of the target task.

Therefore, as in the first example embodiment, a highly accurate model can be efficiently learned (in a short time) from a small number of data, using existing models. Specifically, in this example embodiment, each time a new prediction target sample is obtained, it is simply a matter of performing an operation using the transformation matrix V, which reduces the computation cost. In particular, the prediction accuracy is expected for new samples that can be properly projected by the transformation matrix.

### Example Embodiment 3

Next, the third example embodiment of the learning device according to the present invention will be described. FIG. 6 is a block diagram showing the third example embodiment of the learning device according to the present invention. Similar to the first and second example embodiments, the learning device 300 of this example embodiment comprises a target task attribute estimation unit 110, a prediction value calculation unit 120, and a predictor storage unit 130. However, the target task attribute estimation unit 110 and the prediction value calculation unit 120 of the third example embodiment differ from the first example embodiment and the second example embodiment in their configuration contents.

In this example embodiment, unlike the first and second example embodiments, a situation in which unlabeled data of the target task is obtained is assumed. In the following description, the labeled data of the target task is represented by Equation 7 illustrated below, and the unlabeled data of the target task is represented by Equation 8 illustrated below.

$$[ Math . 7 ]$$

$$\begin{matrix}{\{ ( {x}_{i} , {y}_{i} ) \}}_{i = 1}^{{N}_{T + 1}^{L}} {∼}^{i . i . d .} {p}_{T + 1} ( x , y ) & ( Equation 7 ) \\ {\{ {x}_{j}^{′} \}}_{j = 1}^{{N}_{T + 1}^{U}} {∼}^{i . i . d .} {p}_{T + 1} ( x ) & ( Equation 8 )\end{matrix}$$

The target task attribute estimation unit 110 of this example embodiment includes an attribute vector optimization unit 311.

The attribute vector optimization unit 311 learns a dictionary D that minimizes two terms (hereinafter, referred to as the first optimization term and the second optimization term) for calculating the attribute vector d_{T+1} of the target task. The first optimization term is a term regarding unlabeled data of the target task, and the second optimization term is a term regarding labeled data of the target task.

Specifically, the first optimization term is a term that calculates a norm between the vector h′ᵢ which consists of values obtained by applying the unlabeled samples of the target task to plural existing predictors, and an estimated vector obtained by applying the projection α′ of the unlabeled samples x into the space of the attribute vector d, to the attribute vector d (more specifically, attribute matrix D) used in each of the predictors. The first optimization term is represented by Equation 9, which is illustrated below.

$$[ Math . 8 ]$$

$${J}_{U} ( D , {A}^{′} ) \text{:=} \frac{1}{2 {N}_{T + 1}^{U}} {\sum }_{j = 1}^{{N}_{T + 1}^{U}} {‖ {h}_{j}^{′} - D {α}_{j}^{′} ‖}_{2}^{2} + {λ}_{U} {‖ {α}_{j}^{′} ‖}_{1} \\ {h}_{i}^{′} \text{:=} {( {h}_{1} ( {x}_{i} ) , … , {h}_{T} ( {x}_{i} ) )}^{T} D \text{:=} {( {d}_{1} , … , {d}_{T} )}^{T} \qquad ( Equation 9 )$$

The second optimization term is a term that calculates a norm between the vector h barᵢ (h bar means an overline on h) which consists of values obtained by applying the labeled samples of the target task to the plural existing predictors and the labels y of the samples, and an estimated vector obtained by applying the attribute vector d of the sample x and the projection α of the target task into the space of the attribute vector d_{T+1}, to the attribute vector d (more specifically, the attribute matrix D) used in each of the predictors and the attribute vector d_{T+1} of the target task. The second optimization term is represented by Equation 10 illustrated below.

$$[ Math . 9 ]$$

$${J}_{L} ( \overline{D} , A , {d}_{T + 1} ) \text{:=} \frac{1}{2 {N}_{T + 1}^{L}} {\sum }_{j = 1}^{{N}_{T + 1}^{L}} {‖ {\overline{h}}_{i} - \overline{D} {α}_{i} ‖}_{2}^{2} + {λ}_{L} {‖ {α}_{i} ‖}_{1} \\ {\overline{h}}_{i} \text{:=} {( {h}_{i}^{T} , {y}_{i} )}^{T} \overline{D} \text{:=} {( {D}^{T} , {d}_{T + 1} )}^{T} \qquad ( Equation 10 )$$

The attribute vector optimization unit 311 calculates the attribute vector d and the attribute vector d_{T+1} of the target task by optimizing a sum of the first optimization term and the second optimization term so that the sum is minimized. For example, the attribute vector optimization unit 311 may calculate the attribute vector d and the attribute vector d_{T+1} of the target task by optimizing Equation 11 illustrated below.

$$[ Math . 10 ]$$

$$\hat{D} , {\hat{d}}_{T + 1} , \hat{A} , {\hat{A}}^{′} \text{:=} {argmin}_{{{d}_{t} ∈ ℬ , }_{{α}_{i} , {α}_{j}^{′} ∈ {ℝ}^{p}}} {J}_{L} ( \overline{D} , A , {d}_{T + 1} ) + {J}_{U} ( D , {A}^{′} ) \qquad ( Equation 11 )$$

The prediction value calculation unit 120 of this example embodiment includes a predictor calculation unit 321 and a prediction unit 322.

The predictor calculation unit 321 learns the predictor for the target task. Specifically, the predictor calculation unit 321 learns the predictor so as to minimize the following two terms (hereinafter, referred to as the first learning term and the second learning term). The first learning term is a term regarding unlabeled samples of the target task, and the second learning term is a term regarding labeled samples of the target task.

Specifically, the first learning term is a sum, for each unlabeled sample, of magnitude of the difference between a value obtained by applying the predictor to a result of applying the unlabeled sample to the mapping function φ shown in the second example embodiment, and a value obtained by applying the projection α′ of the unlabeled sample to the estimated attribute vector d_{T+1}.

The second learning term is a sum, for each labeled sample, of magnitude of the difference between a value obtained by applying the predictor to a result, calculated under the predetermined ratio γ, of applying the labeled sample to the mapping function φ and the label of the labeled sample, and magnitude of the difference between a value obtained by applying the predictor to a result of applying the labeled sample to the mapping function φ and a value obtained by applying the projection α of the labeled sample to the vector d_{T+1} of the target task.

The predictor calculation unit 321 learns the predictor so as to minimize the sum of the first learning term and the second learning term. For example, the predictor calculation unit 321 may learn the predictor using Equation 12 illustrated below.

$$[ Math . 11 ]$$

$$\hat{w} \text{:=} {argmin}_{w ∈ {ℝ}^{b}} \frac{1}{{N}_{T + 1}^{L}} ( ( 1 - γ ) {( {y}_{i} - {w}^{T} ϕ ( {x}_{i} ) )}^{2} + {γ ( {\hat{d}}_{T + 1}^{T} {\hat{α}}_{i} - {w}^{T} ϕ ( {x}_{i} ) )}^{2} ) + \frac{η}{{N}_{T + 1}^{U}} {\sum }_{j = 1}^{{N}_{T + 1}^{U}} {( {\hat{d}}_{T + 1}^{T} {\hat{α}}_{j}^{′} - {w}^{T} ϕ ( {x}_{j}^{′} ) )}^{2} \\ 0 \leq γ , η \leq 1 w ∈ {ℝ}^{b} \qquad ( Equation 12 )$$

The prediction unit 322 calculates a prediction value by applying a result of applying the prediction target sample x_{new} to the mapping function φ, to the predictor w. For example, the prediction unit 322 may calculate the prediction value using Equation 13 illustrated below.

[Math. 12]

y=ŵ^{T}ϕ(x_{new}) (Equation 13)

The target task attribute estimation unit 110 (more specifically, the attribute vector optimization unit 311) and the prediction value calculation unit 120 (more specifically, the predictor calculation unit 321 and the prediction unit 322) are realized by a processor of a computer that operates according to a program (learning program).

Next, the example of operation of the learning device of this example embodiment will be described. FIG. 7 is a flowchart showing an example of operation of the learning device 300 of this example embodiment.

The attribute vector optimization unit 311 calculates the attribute vector and the attribute vector d_{T+1} of the target task, so that the sum of the norm (first optimization term), which is a norm between a result of applying the unlabeled sample to the predictor and a result of applying the projection of the unlabeled sample into a space of the attribute vector to the attribute vector of the predictor, and the norm (second optimization term), which is a norm between a vector including a result of applying the labeled sample to the predictor and the label of the labeled sample, and a result of applying the attribute vector of the labeled sample and the projection of the target task into the space of the attribute vector to the attribute vector of the predictor and the attribute vector of the target task, is minimized (step S41).

The predictor calculation unit 321 calculates a predictor w that minimizes a total of a sum (second learning term), for each labeled sample, of magnitude of a difference between a value obtained by applying the predictor to a result, calculated under the predetermined ratio γ, of applying the labeled sample to the mapping function φ and the label of the labeled sample, and magnitude of a difference between a value obtained by applying the predictor to a result of applying the labeled sample to the mapping function φ and a value obtained by applying the projection of the labeled sample to the attribute vector d_{T+1} of the target task, and a sum (first learning term), for each unlabeled sample, of magnitude of a difference between the value obtained by applying the predictor to a result of applying the unlabeled sample to the mapping function φ and a value obtained by applying the projection of the unlabeled sample to the attribute vector d_{T+1} (step S42).

The prediction unit 322 calculates a prediction value by applying a result of applying the prediction target sample x_{new} to the mapping function φ, to the predictor (step S43).

As described above, in this example embodiment, the attribute vector optimization unit 311 calculates the attribute vector and the attribute vector d_{T+1} of the target task so that the sum of the first optimization term and the second optimization term is minimized, and the predictor calculation unit 321 calculates a predictor that minimizes the sum of the second learning term and the first learning term. Then, the prediction unit 322 calculates the prediction value by applying the result of applying the prediction target sample x_{new} to the mapping function φ, to the predictor.

Therefore, as in the first and second example embodiments, a highly accurate model can be efficiently learned (in a short time) from a small number of data, using existing models. Specifically, while arbitrary unlabeled samples are assumed in the first and second example embodiments, in this example embodiment, the case where unlabeled samples of the target task are given in advance is assumed. This corresponds to the so-called semi-supervised learning, and since the labeled samples can be used directly and the information on the distribution about the samples of the target task can be used, the accuracy may be higher than in the first and second example embodiments.

### Example Embodiment 4

Next, the fourth example embodiment of the learning device according to the present invention will be described. FIG. 8 is a block diagram showing the fourth example embodiment of the learning device according to the present invention. The learning device 400 of this example embodiment comprises a target task attribute estimation unit 110, a prediction value calculation unit 120, a predictor storage unit 130, a model evaluation unit 140, and an output unit 150.

As the structure of the target task attribute estimation unit 110 and the prediction value calculation unit 120 of this example embodiment, those in any one of the first, second and third example embodiments can be utilized. The structure of the predictor storage unit 130 are the same as it in the example embodiments described above.

The model evaluation unit 140 evaluates similarity between the attribute vector of the learned predictor and the attribute vector of the predictor that predicts the estimated target task. The method by which the model evaluation unit 140 evaluates the similarity of the attribute vectors is arbitrary. For example, the model evaluation unit 140 may evaluate the similarity by calculating cosine similarity as illustrated in Equation 14 below.

$$[ Math . 13 ]$$

$${s}_{ij} = \frac{{d}_{i}^{T} {d}_{j}}{‖ {d}_{i} ‖ ‖ {d}_{j} ‖} \qquad ( Equation 14 )$$

The output unit 150 visualizes the similarity between the predictors in a manner according to the similarity. FIG. 9 is an explanatory diagram showing an example of the process of visualizing similarity. The output unit 150 may display the similarity of the two predictors in a matrix form and visualize the similarity of respective predictors in a manner that allows distinguishing between the two predictors at corresponding positions, as illustrated in FIG. 9. In FIG. 9, an example is shown in which cells with high similarity are visualized in darker colors and cells with low similarity are visualized in lighter colors.

Thus, by visualizing a relationship between predictors (i.e., tasks) with similarities, it is possible to use them to make decisions, for example, on campaigns.

Next, an overview of the present invention will be explained. FIG. 10 is a block diagram showing a summarized learning device according to the present invention. The learning device 80 (for example, learning device 100-400) according to the present invention comprises a target task attribute estimation unit 81 (for example, target task attribute estimation unit 110) which estimates an attribute vector (for example, attribute vector d, attribute matrix D) of an existing predictor (for example, hₜ) based on samples in a domain of a target task, and estimates an attribute vector of the target task based on a transformation method (for example, projection α) for transforming labeled samples into a space consisting of the attribute vector estimated based on a result (for example, hₜ(x) of applying the labeled samples of the target task to the predictor, and a prediction value calculation unit 82 (for example, prediction value calculation unit 120) which calculates a prediction value of a prediction target sample (for example, x_{new}) to be transformed by the transformation method based on the attribute vector of the target task.

By such a configuration, a highly accurate model can be learned from a small number of data using existing models.

In addition, the target task attribute estimating unit 81 may include an attribute vector estimation unit (for example, attribute vector estimating unit 112) which estimates each attribute vector used in each of the predictors, from outputs obtained by applying the samples in the domain of the target task to plural existing predictors, a first projection calculation unit (for example, the first projection calculation unit 113) which calculates projection (for example, α), that is applied to the estimated attribute vector to obtain a first estimated value, of each labeled sample, so that a difference between a value obtained by applying the labeled sample to the predictor and the first estimated value is minimized, and a target attribute vector calculation unit (for example, target attribute vector calculation unit 114) which calculates an attribute vector (for example, d_{T+1}), that is applied to the projection to obtain a second estimated value, of the target task, so that a difference between a label (for example, y) of the labeled sample and the second estimated value is minimized

Then, the prediction calculating unit 82 may include a second projection calculation unit (for example, second projection calculating unit 121) which calculates projection (for example, projection α\hat{ }_{new}), that is applied to the estimated attribute vector to obtain a third estimated value, of the prediction target sample (for example, sample x_{new}), so that a difference between a value obtained by applying the prediction target sample to the predictor and the third estimated value is minimized, and a prediction unit (for example, second projection calculation unit 121) which calculates the prediction value by applying the projection to the attribute vector of the target task.

By such a configuration, it becomes to be possible to perform more accurate prediction by calculating the projection vector each time a new sample to be predicted is obtained.

As another configuration, the target task attribute estimation unit 81 may include a transformation estimation unit (for example, transformation estimation unit 212) which estimates a transformation matrix (for example, transformation matrix V) that transforms outputs (samples+values) into the space of the attribute vector, from said outputs of the predictors obtained by applying the samples in the domain of the target task to plural predictors, and an attribute vector calculation unit (for example, attribute vector calculation unit 213) which calculates the attribute vector, that is applied to a product of the transformation matrix and a mapping function (for example, mapping function φ) representing transformation between attributes to obtain an estimated value, of the target task, so that a difference between a label of the labeled sample and the estimated value is minimized.

Then, the prediction calculation unit 82 may include a prediction unit (for example, prediction unit 222) which calculates the prediction value by applying the transformation matrix and a result of applying the prediction target sample to the mapping function, to the attribute vector of the target task.

By such a configuration, each time a new prediction target sample is obtained, it is simply a matter of performing an operation using the transformation matrix V, which reduces the computation cost. In particular, the prediction accuracy is expected for new samples that can be properly projected by the transformation matrix.

Furthermore, as another configuration, the target task attribute estimation unit 81 may include an attribute vector optimization unit (for example, attribute vector optimization unit 311) which, when a norm between a vector that consists of values obtained by applying unlabeled samples of the target task to plural predictors, and a vector obtained by applying projection of the unlabeled samples into the space of the attribute vector, to each attribute vector used in each of the predictors, is regarded as a first optimization term, and a norm between a vector that consists of values obtained by applying the labeled samples of the target task to the plural predictors and the labels of the labeled samples, and a vector obtained by applying the attribute vectors of the labeled samples and projection of the target task into the space of the attribute vector, to each attribute vector used in each of the predictors and the attribute vector of the target task, is regarded as a second optimization term, calculates the attribute vector and the attribute vector of the target task, so that a sum of the first optimization term and the second optimization term is minimized.

Then, the prediction calculation unit 82 may include a predictor calculation unit (for example, predictor calculation unit 321) which calculates the predictor minimizing a sum of a total of a sum, for each labeled sample, of magnitude of a difference between a value obtained by applying the predictor to a result, calculated under the predetermined ratio (for example, ratio γ), of applying the labeled sample to a mapping function (for example, mapping function φ) representing transformation between attributes and label of the labeled sample, and magnitude of a difference between a value obtained by applying the predictor to a result of applying the labeled sample to the mapping function and a value obtained by applying the projection of the labeled sample to the attribute vector of the target task, and a total sum, for each unlabeled sample, of magnitude of a difference between a value obtained by applying the predictor to a result of applying the unlabeled sample to the mapping function, and a value obtained by applying the projection of the unlabeled sample to the attribute vector, and a prediction unit (for example, prediction unit 322) which calculates the prediction value by applying a result of applying the prediction target sample to the mapping function, to the predictor.

By such a configuration, when unlabeled samples of the target task are given in advance (in the case of so-called semi-supervised learning), since the labeled samples can be used directly and the information on the distribution about the samples of the target task can be used, the accuracy may be further improved.

Further, the learning device 80 may comprise a model evaluation unit (for example, model evaluation unit 140) which evaluates similarity between the attribute vector of the existing predictor and the attribute vector of the predictor that predicts estimated target task, and an output unit (for example, output unit 150) which visualizes the similarity between the predictors in a manner according to the similarity.

FIG. 11 is a summarized block diagram showing a configuration of a computer for at least one example embodiment. The computer 1000 comprises a processor 1001, a main memory 1002, an auxiliary memory 1003, and an interface 1004.

The learning device described above is implemented in the computer 1000. The operation of each of the above mentioned processing units is stored in the auxiliary memory 1003 in a form of a program (learning program). The processor 1001 reads the program from the auxiliary memory 1003, deploys the program to the main memory 1002, and implements the above described processing in accordance with the program.

In at least one exemplary embodiment, the auxiliary memory 1003 is an example of a non-transitory tangible medium. Other examples of non-transitory tangible media include a magnetic disk, an optical magnetic disk, a CD-ROM (Compact Disc Read only memory), a DVD-ROM (Read-only memory), a semiconductor memory, and the like. When the program is transmitted to the computer 1000 through a communication line, the computer 1000 receiving the transmission may deploy the program to the main memory 1002 and perform the above process.

The program may also be one for realizing some of the aforementioned functions. Furthermore, said program may be a so-called differential file (differential program), which realizes the aforementioned functions in combination with other programs already stored in the auxiliary memory 1003.

Some or all of the above example embodiments can be described as in the following supplementary notes, but are not limited to the following supplementary notes.

(Supplementary note 1) A learning device comprising:

a target task attribute estimation unit which estimates an attribute vector of an existing predictor based on samples in a domain of a target task, and estimates an attribute vector of the target task based on a transformation method for transforming labeled samples into a space consisting of the attribute vector estimated based on a result of applying the labeled samples of the target task to the predictor; and

a prediction value calculation unit which calculates a prediction value of a prediction target sample to be transformed by the transformation method based on the attribute vector of the target task.

(Supplementary note 2) The learning device according to Supplementary note 1,

wherein the target task attribute estimation unit includes:

an attribute vector estimation unit which estimates each attribute vector used in each of the predictors, from outputs obtained by applying the samples in the domain of the target task to plural existing predictors;

a first projection calculation unit which calculates projection, that is applied to the estimated attribute vector to obtain a first estimated value, of each labeled sample, so that a difference between a value obtained by applying the labeled sample to the predictor and the first estimated value is minimized; and

a target attribute vector calculation unit which calculates an attribute vector, that is applied to the projection to obtain a second estimated value, of the target task, so that a difference between a label of the labeled sample and the second estimated value is minimized, and

wherein the prediction value calculation unit includes:

a second projection calculation unit which calculates projection, that is applied to the estimated attribute vector to obtain a third estimated value, of the prediction target sample, so that a difference between a value obtained by applying the prediction target sample to the predictor and the third estimated value is minimized; and

a prediction unit which calculates the prediction value by applying the projection to the attribute vector of the target task.

(Supplementary note 3) The learning device according to Supplementary note 1,

wherein the target task attribute estimation unit includes:

a transformation estimation unit which estimates a transformation matrix that transforms outputs into the space of the attribute vector, from said outputs of the predictors obtained by applying the samples in the domain of the target task to plural predictors; and

an attribute vector calculation unit which calculates the attribute vector, that is applied to a product of the transformation matrix and a mapping function representing transformation between attributes to obtain an estimated value, of the target task, so that a difference between a label of the labeled sample and the estimated value is minimized, and

wherein the prediction value calculation unit includes

a prediction unit which calculates the prediction value by applying the transformation matrix and a result of applying the prediction target sample to the mapping function, to the attribute vector of the target task.

(Supplementary note 4) The learning device according to Supplementary note 1,

wherein the target task attribute estimation unit includes an attribute vector optimization unit which,

when a norm between a vector that consists of values obtained by applying unlabeled samples of the target task to plural predictors, and a vector obtained by applying projection of the unlabeled samples into the space of the attribute vector, to each attribute vector used in each of the predictors, is regarded as a first optimization term, and a norm between a vector that consists of values obtained by applying the labeled samples of the target task to the plural predictors and the labels of the labeled samples, and a vector obtained by applying the attribute vectors of the labeled samples and projection of the target task into the space of the attribute vector, to each attribute vector used in each of the predictors and the attribute vector of the target task, is regarded as a second optimization term,

calculates the attribute vector and the attribute vector of the target task, so that a sum of the first optimization term and the second optimization term is minimized, and

wherein the prediction value calculation unit includes:

a predictor calculation unit which calculates the predictor minimizing a sum of a total sum, for each labeled sample, of magnitude of a difference between a value obtained by applying the predictor to a result, calculated under the predetermined ratio, of applying the labeled sample to a mapping function representing transformation between attributes and label of the labeled sample, and magnitude of a difference between a value obtained by applying the predictor to a result of applying the labeled sample to the mapping function and a value obtained by applying the projection of the labeled sample to the attribute vector of the target task, and a total sum, for each unlabeled sample, of magnitude of a difference between a value obtained by applying the predictor to a result of applying the unlabeled sample to the mapping function, and a value obtained by applying the projection of the unlabeled sample to the attribute vector; and

a prediction unit which calculates the prediction value by applying a result of applying the prediction target sample to the mapping function, to the predictor.

(Supplementary note 5) The learning device according to any one of Supplementary notes 1 to 4, further comprising:

a model evaluation unit which evaluates similarity between the attribute vector of the existing predictor and the attribute vector of the predictor that predicts estimated target task; and

an output unit which visualizes the similarity between the predictors in a manner according to the similarity.

(Supplementary note 6) A learning method, executed by a computer, comprising:

estimating an attribute vector of an existing predictor based on samples in a domain of a target task, and estimating an attribute vector of the target task based on a transformation method for transforming labeled samples into a space consisting of the attribute vector estimated based on a result of applying the labeled samples of the target task to the predictor; and

calculating a prediction value of a prediction target sample to be transformed by the transformation method based on the attribute vector of the target task.

(Supplementary note 7) The learning method, executed by a computer, according to Supplementary note 6, comprising:

estimating each attribute vector used in each of the predictors, from outputs obtained by applying the samples in the domain of the target task to plural existing predictors;

calculating projection, that is applied to the estimated attribute vector to obtain a first estimated value, of each labeled sample, so that a difference between a value obtained by applying the labeled sample to the predictor and the first estimated value is minimized;

calculating an attribute vector, that is applied to projection to obtain a second estimated value, of the target task, so that a difference between a label of the labeled sample and the second estimated value is minimized;

calculating projection, that is applied to the estimated attribute vector to obtain a third estimated value, of the prediction target sample, so that a difference between a value obtained by applying the prediction target sample to the predictor and the third estimated value is minimized; and

calculating the prediction value by applying the projection to the attribute vector of the target task.

(Supplementary note 8) The learning method, executed by a computer, according to Supplementary note 6, comprising:

estimating a transformation matrix that transforms outputs into the space of the attribute vector, from said outputs of the predictors obtained by applying the samples in the domain of the target task to plural predictors;

calculating the attribute vector, that is applied to a product of the transformation matrix and a mapping function representing transformation between attributes to obtain an estimated value, of the target task, so that a difference between a label of the labeled sample and the estimated value is minimized; and

calculating the prediction value by applying the transformation matrix and a result of applying the prediction target sample to the mapping function, to the attribute vector of the target task.

(Supplementary note 9) The learning method, executed by a computer, according to Supplementary note 6, comprising:

when a norm between a vector that consists of values obtained by applying unlabeled samples of the target task to plural predictors, and a vector obtained by applying projection of the unlabeled samples into the space of the attribute vector, to each attribute vector used in each of the predictors, is regarded as a first optimization term, and a norm between a vector that consists of values obtained by applying the labeled samples of the target task to the plural predictors and the labels of the labeled samples, and a vector obtained by applying the attribute vectors of the labeled samples and projection of the target task into the space of the attribute vector, to each attribute vector used in each of the predictors and the attribute vector of the target task, is regarded as a second optimization term, calculating the attribute vector and the attribute vector of the target task, so that a sum of the first optimization term and the second optimization term is minimized;

calculating the predictor minimizing a sum of a total sum, for each labeled sample, of magnitude of a difference between a value obtained by applying the predictor to a result, calculated under the predetermined ratio, of applying the labeled sample to a mapping function representing transformation between attributes and label of the labeled sample, and magnitude of a difference between a value obtained by applying the predictor to a result of applying the labeled sample to the mapping function and a value obtained by applying projection of the labeled sample to the attribute vector of the target task, and a total sum, for each unlabeled sample, of magnitude of a difference between a value obtained by applying the predictor to a result of applying the unlabeled sample to the mapping function, and a value obtained by applying the projection of the unlabeled sample to the attribute vector; and

calculating the prediction value by applying a result of applying the prediction target sample to the mapping function, to the predictor.

(Supplementary note 10) A learning program causing a computer to execute:

a target task attribute estimation process of estimating an attribute vector of an existing predictor based on samples in a domain of a target task, and estimating an attribute vector of the target task based on a transformation method for transforming labeled samples into a space consisting of the attribute vector estimated based on a result of applying the labeled samples of the target task to the predictor; and

a prediction value calculation process of calculating a prediction value of a prediction target sample to be transformed by the transformation method based on the attribute vector of the target task.

(Supplementary note 11) The learning program according to Supplementary note 10, wherein

in the target task attribute estimation process, the learning program causes the computer to execute:

an attribute vector estimation process of estimating each attribute vector used in each of the predictors, from outputs obtained by applying the samples in the domain of the target task to plural existing predictors;

a first projection calculation process of calculating projection, that is applied to the estimated attribute vector to obtain a first estimated value, of each labeled sample, so that a difference between a value obtained by applying the labeled sample to the predictor and the first estimated value is minimized; and

a target attribute vector calculation process of calculating an attribute vector, that is applied to projection to obtain a second estimated value, of the target task, so that a difference between a label of the labeled sample and the second estimated value is minimized, and

in the prediction value calculation process, the learning program causes the computer to execute:

a second projection calculation process of calculating projection, that is applied to the estimated attribute vector to obtain a third estimated value, of the prediction target sample, so that a difference between a value obtained by applying the prediction target sample to the predictor and the third estimated value is minimized; and

a prediction process of calculating the prediction value by applying the projection to the attribute vector of the target task.

(Supplementary note 12) The learning program according to Supplementary note 10, wherein

in the target task attribute estimation process, the learning program causes the computer to execute:

a transformation estimation process of estimating a transformation matrix that transforms outputs into the space of the attribute vector, from said outputs of the predictors obtained by applying the samples in the domain of the target task to plural predictors; and

an attribute vector calculation process of calculating the attribute vector, that is applied to a product of the transformation matrix and a mapping function representing transformation between attributes to obtain an estimated value, of the target task, so that a difference between a label of the labeled sample and the estimated value is minimized, and

in the prediction value calculation process, the learning program causes the computer to execute

a prediction process of calculating the prediction value by applying the transformation matrix and a result of applying the prediction target sample to the mapping function, to the attribute vector of the target task.

(Supplementary note 13) The learning program according to Supplementary note 10, wherein

in the target task attribute estimation process, the learning program causes the computer to execute:

when a norm between a vector that consists of values obtained by applying unlabeled samples of the target task to plural predictors, and a vector obtained by applying projection of the unlabeled samples into the space of the attribute vector, to each attribute vector used in each of the predictors, is regarded as a first optimization term, and a norm between a vector that consists of values obtained by applying the labeled samples of the target task to the plural predictors and the labels of the labeled samples, and a vector obtained by applying the attribute vectors of the labeled samples and projection of the target task into the space of the attribute vector, to each attribute vector used in each of the predictors and the attribute vector of the target task, is regarded as a second optimization term,

an attribute vector optimization process of calculating the attribute vector and the attribute vector of the target task, so that a sum of the first optimization term and the second optimization term is minimized, and

in the prediction value calculation process, the learning program further causes the computer to execute:

a predictor calculation process of calculating the predictor minimizing a sum of a total sum, for each labeled sample, of magnitude of a difference between a value obtained by applying the predictor to a result, calculated under the predetermined ratio, of applying the labeled sample to a mapping function representing transformation between attributes and label of the labeled sample, and magnitude of a difference between a value obtained by applying the predictor to a result of applying the labeled sample to the mapping function and a value obtained by applying the projection of the labeled sample to the attribute vector of the target task, and a total sum, for each unlabeled sample, of magnitude of a difference between a value obtained by applying the predictor to a result of applying the unlabeled sample to the mapping function, and a value obtained by applying the projection of the unlabeled sample to the attribute vector, and

a prediction process of calculating the prediction value by applying a result of applying the prediction target sample to the mapping function, to the predictor.

### REFERENCE SIGNS LIST

100, 200, 300, 400 Learning device

110 Target task attribute estimation unit

111 Sample generation unit

112 Attribute vector estimation unit

113 First projection calculation unit

114 Target attribute vector calculation unit

120 Prediction value calculation unit

121 Second projection calculation unit

122 Prediction unit

130 Predictor storage unit

211 Sample generation unit

212 Transformation estimation unit

213 Attribute vector calculation unit

222 Prediction unit

311 Attribute vector optimization unit

321 Predictor calculation unit

322 Prediction unit

What is claimed is:

1. A learning device comprising a hardware processor configured to execute a software code to:
estimate an attribute vector of an existing predictor based on samples in a domain of a target task, and estimate an attribute vector of the target task based on a transformation method for transforming labeled samples into a space consisting of the attribute vector estimated based on a result of applying the labeled samples of the target task to the predictor; and
calculate a prediction value of a prediction target sample to be transformed by the transformation method based on the attribute vector of the target task.

2. The learning device according to claim 1, wherein the hardware processor is configured to execute a software code to:
estimate each attribute vector used in each of the predictors, from outputs obtained by applying the samples in the domain of the target task to plural existing predictors;
calculate projection, that is applied to the estimated attribute vector to obtain a first estimated value, of each labeled sample, so that a difference between a value obtained by applying the labeled sample to the predictor and the first estimated value is minimized;
calculate an attribute vector, that is applied to the projection to obtain a second estimated value, of the target task, so that a difference between a label of the labeled sample and the second estimated value is minimized;
calculate projection, that is applied to the estimated attribute vector to obtain a third estimated value, of the prediction target sample, so that a difference between a value obtained by applying the prediction target sample to the predictor and the third estimated value is minimized; and
calculate the prediction value by applying the projection to the attribute vector of the target task.

3. The learning device according to claim 1, wherein the hardware processor is configured to execute a software code to:
estimate a transformation matrix that transforms outputs into the space of the attribute vector, from said outputs of the predictors obtained by applying the samples in the domain of the target task to plural predictors;
calculate the attribute vector, that is applied to a product of the transformation matrix and a mapping function representing transformation between attributes to obtain an estimated value, of the target task, so that a difference between a label of the labeled sample and the estimated value is minimized; and
calculate the prediction value by applying the transformation matrix and a result of applying the prediction target sample to the mapping function, to the attribute vector of the target task.

4. The learning device according to claim 1, wherein the hardware processor is configured to execute a software code to:
when a norm between a vector that consists of values obtained by applying unlabeled samples of the target task to plural predictors, and a vector obtained by applying projection of the unlabeled samples into the space of the attribute vector, to each attribute vector used in each of the predictors, is regarded as a first optimization term, and a norm between a vector that consists of values obtained by applying the labeled samples of the target task to the plural predictors and the labels of the labeled samples, and a vector obtained by applying the attribute vectors of the labeled samples and projection of the target task into the space of the attribute vector, to each attribute vector used in each of the predictors and the attribute vector of the target task, is regarded as a second optimization term,
calculate the attribute vector and the attribute vector of the target task, so that a sum of the first optimization term and the second optimization term is minimized;
calculate the predictor minimizing a sum of a total sum, for each labeled sample, of magnitude of a difference between a value obtained by applying the predictor to a result, calculated under the predetermined ratio, of applying the labeled sample to a mapping function representing transformation between attributes and label of the labeled sample, and magnitude of a difference between a value obtained by applying the predictor to a result of applying the labeled sample to the mapping function and a value obtained by applying the projection of the labeled sample to the attribute vector of the target task, and a total sum, for each unlabeled sample, of magnitude of a difference between a value obtained by applying the predictor to a result of applying the unlabeled sample to the mapping function, and a value obtained by applying the projection of the unlabeled sample to the attribute vector; and
calculate the prediction value by applying a result of applying the prediction target sample to the mapping function, to the predictor.

5. The learning device according to claim 1, wherein the hardware processor is configured to execute a software code to:
evaluate similarity between the attribute vector of the existing predictor and the attribute vector of the predictor that predicts estimated target task; and
visualize the similarity between the predictors in a manner according to the similarity.

6. A learning method, executed by a computer, comprising:
estimating an attribute vector of an existing predictor based on samples in a domain of a target task, and estimating an attribute vector of the target task based on a transformation method for transforming labeled samples into a space consisting of the attribute vector estimated based on a result of applying the labeled samples of the target task to the predictor; and
calculating a prediction value of a prediction target sample to be transformed by the transformation method based on the attribute vector of the target task.

7. The learning method, executed by a computer, according to claim 6, comprising:
estimating each attribute vector used in each of the predictors, from outputs obtained by applying the samples in the domain of the target task to plural existing predictors;
calculating projection, that is applied to the estimated attribute vector to obtain a first estimated value, of each labeled sample, so that a difference between a value obtained by applying the labeled sample to the predictor and the first estimated value is minimized;
calculating an attribute vector, that is applied to projection to obtain a second estimated value, of the target task, so that a difference between a label of the labeled sample and the second estimated value is minimized;
calculating projection, that is applied to the estimated attribute vector to obtain a third estimated value, of the prediction target sample, so that a difference between a value obtained by applying the prediction target sample to the predictor and the third estimated value is minimized; and
calculating the prediction value by applying the projection to the attribute vector of the target task.

8. The learning method, executed by a computer, according to claim 6, comprising:
estimating a transformation matrix that transforms outputs into the space of the attribute vector, from said outputs of the predictors obtained by applying the samples in the domain of the target task to plural predictors;
calculating the attribute vector, that is applied to a product of the transformation matrix and a mapping function representing transformation between attributes to obtain an estimated value, of the target task, so that a difference between a label of the labeled sample and the estimated value is minimized; and
calculating the prediction value by applying the transformation matrix and a result of applying the prediction target sample to the mapping function, to the attribute vector of the target task.

9. The learning method, executed by a computer, according to claim 6, comprising:
when a norm between a vector that consists of values obtained by applying unlabeled samples of the target task to plural predictors, and a vector obtained by applying projection of the unlabeled samples into the space of the attribute vector, to each attribute vector used in each of the predictors, is regarded as a first optimization term, and a norm between a vector that consists of values obtained by applying the labeled samples of the target task to the plural predictors and the labels of the labeled samples, and a vector obtained by applying the attribute vectors of the labeled samples and projection of the target task into the space of the attribute vector, to each attribute vector used in each of the predictors and the attribute vector of the target task, is regarded as a second optimization term, calculating the attribute vector and the attribute vector of the target task, so that a sum of the first optimization term and the second optimization term is minimized;
calculating the predictor minimizing a sum of a total sum, for each labeled sample, of magnitude of a difference between a value obtained by applying the predictor to a result, calculated under the predetermined ratio, of applying the labeled sample to a mapping function representing transformation between attributes and label of the labeled sample, and magnitude of a difference between a value obtained by applying the predictor to a result of applying the labeled sample to the mapping function and a value obtained by applying projection of the labeled sample to the attribute vector of the target task, and a total sum, for each unlabeled sample, of magnitude of a difference between a value obtained by applying the predictor to a result of applying the unlabeled sample to the mapping function, and a value obtained by applying the projection of the unlabeled sample to the attribute vector; and
calculating the prediction value by applying a result of applying the prediction target sample to the mapping function, to the predictor.

10. A non-transitory computer readable information recording medium storing a learning program, when executed by a processor, that performs a method for:
estimating an attribute vector of an existing predictor based on samples in a domain of a target task, and estimating an attribute vector of the target task based on a transformation method for transforming labeled samples into a space consisting of the attribute vector estimated based on a result of applying the labeled samples of the target task to the predictor; and
calculating a prediction value of a prediction target sample to be transformed by the transformation method based on the attribute vector of the target task.

11. The non-transitory computer readable information recording medium according to claim 10, further comprising:
estimating each attribute vector used in each of the predictors, from outputs obtained by applying the samples in the domain of the target task to plural existing predictors;
calculating projection, that is applied to the estimated attribute vector to obtain a first estimated value, of each labeled sample, so that a difference between a value obtained by applying the labeled sample to the predictor and the first estimated value is minimized;
calculating an attribute vector, that is applied to projection to obtain a second estimated value, of the target task, so that a difference between a label of the labeled sample and the second estimated value is minimized;
calculating projection, that is applied to the estimated attribute vector to obtain a third estimated value, of the prediction target sample, so that a difference between a value obtained by applying the prediction target sample to the predictor and the third estimated value is minimized; and
calculating the prediction value by applying the projection to the attribute vector of the target task.

12. The non-transitory computer readable information recording medium according to claim 10, further comprising:
estimating a transformation matrix that transforms outputs into the space of the attribute vector, from said outputs of the predictors obtained by applying the samples in the domain of the target task to plural predictors;
calculating the attribute vector, that is applied to a product of the transformation matrix and a mapping function representing transformation between attributes to obtain an estimated value, of the target task, so that a difference between a label of the labeled sample and the estimated value is minimized; and
calculating the prediction value by applying the transformation matrix and a result of applying the prediction target sample to the mapping function, to the attribute vector of the target task.

13. The non-transitory computer readable information recording medium according to claim 10, further comprising:
when a norm between a vector that consists of values obtained by applying unlabeled samples of the target task to plural predictors, and a vector obtained by applying projection of the unlabeled samples into the space of the attribute vector, to each attribute vector used in each of the predictors, is regarded as a first optimization term, and a norm between a vector that consists of values obtained by applying the labeled samples of the target task to the plural predictors and the labels of the labeled samples, and a vector obtained by applying the attribute vectors of the labeled samples and projection of the target task into the space of the attribute vector, to each attribute vector used in each of the predictors and the attribute vector of the target task, is regarded as a second optimization term,
calculating the attribute vector and the attribute vector of the target task, so that a sum of the first optimization term and the second optimization term is minimized;
calculating the predictor minimizing a sum of a total sum, for each labeled sample, of magnitude of a difference between a value obtained by applying the predictor to a result, calculated under the predetermined ratio, of applying the labeled sample to a mapping function representing transformation between attributes and label of the labeled sample, and magnitude of a difference between a value obtained by applying the predictor to a result of applying the labeled sample to the mapping function and a value obtained by applying the projection of the labeled sample to the attribute vector of the target task, and a total sum, for each unlabeled sample, of magnitude of a difference between a value obtained by applying the predictor to a result of applying the unlabeled sample to the mapping function, and a value obtained by applying the projection of the unlabeled sample to the attribute vector; and
calculating the prediction value by applying a result of applying the prediction target sample to the mapping function, to the predictor.
